(19) United States
(12) Patent Application Publication
(10) Pub. No.: US 2013/0220821 A1
(43) Pub. Date: Aug. 29, 2013

(54) ARTICLE COMPRISING SILICON NANOWIRES ON A METAL SUBSTRATE

(71) Applicants: Jeong-Hyun Cho, Los Alamos, NM (US); Samuel Thomas Picraux, Albuquerque, NM (US)

(72) Inventors: Jeong-Hyun Cho, Los Alamos, NM (US); Samuel Thomas Picraux, Albuquerque, NM (US)

(73) Assignee: LOS ALAMOS NATIONAL SECURITY, LLC, Los Alamos, NM (US)

(21) Appl. No.: 13/619,272

(22) Filed: Sep. 14, 2012

Related U.S. Application Data
(60) Provisional application No. 61/603,803, filed on Feb. 27, 2012.

(51) Int. Cl. C25D 5/02; H01M 10/04; H01M 4/64; H01M 4/66; B82Y 40/00; B82Y 30/00

(52) U.S. Cl. 205/122; 429/211; 29/623.5; 977/780; 977/762; 977/888; 977/840; 977/948

(57) ABSTRACT

Articles of silicon nanowires were synthesized on metal substrates. The preparation minimized the formation of metal silicides and avoided the formation of islands of silicon on the metal substrates. These articles may be used as electrodes of silicon nanowires on current collectors.

### RELATED APPLICATIONS

This application claims the benefit of U.S. Provisional Patent Application No. 61/603,803 entitled “PREPARATION OF ANODE COMPRISING SILCON NANO WIRES,” filed Feb. 27, 2012, hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to articles that include nanowires on a is metal substrate and to the preparation of these articles.

### BACKGROUND OF THE INVENTION

Lithium-ion batteries are widely used in portable electronic systems and electronic vehicles because of their relatively high energy density, lack of a memory effect, and low self-discharge. Commercially available lithium-ion batteries are rechargeable and widely used in consumer electronics. Anodes of lithium-ion batteries are made of graphite and have a theoretical specific capacity of 372 milliampere-hours per gram (mA·h/g). This value can be increased to about 4200 mA·h/g by replacing the graphite with silicon, but the mechanical stress due to a huge volume increase of approximately 300% upon lithiation quickly degrades the electrode and leads to a partial loss of electrical contact between the silicon and the metal current collector. Loss of electrical contact leads to capacity fade during cycling, which results in poor cycling performance.

Silicon nanowires (SiNWs) that have been synthesized directly onto metal current collectors have shown promise for improved electrical connection between the silicon nanowires and the current collector while providing a high capacity. However, the CVD process used for synthesizing the nanowires directly on the current collectors also results in formation of small islands of silicon on the current collectors. These islands are quickly pulverized during cycling (i.e. charging and discharging). This pulverization leads to loss of electrical contact between the current collector and any silicon nanowires grown on top of the silicon islands. This loss of electrical contact leads to capacity fade during cycling, which results in poor cycling performance. In addition, silicon reacts at elevated temperatures with many transition metals that make up the current collector. The reaction produces metal silicides. Metal silicides have one to two orders of magnitude lower specific capacity than silicon. Therefore, the presence of metal silicides lowers the specific capacity of the anode.

The synthesis of an anode of silicon nanowire anodes directly on a current collector while preventing the formation of silicon islands on the current collector is desirable. Also desirable is the synthesis of an anode of silicon nanowires directly on a current collector while minimizing the competing formation of metal silicides.

### SUMMARY OF THE INVENTION

The present invention provides an article prepared by a process that involves forming a template on a metal substrate. The template includes nanopores that extend through the template to the substrate. Nanowires of silicon are formed inside the nanopores. The nanowires may be long enough to extend until a portion of the nanowires is outside the template. After forming the nanowires of silicon, the template is removed. The resulting article is an article of silicon nanowires on the substrate. The article may function as an electrode (i.e. the silicon nanowires) a current collector (i.e. the metal substrate).

The invention also includes an article prepared by a process comprising forming a template on a metal substrate, the template comprising nanopores that extend through the template to the current collector. Afterward, nanowires of silicon are formed inside the nanopores. The nanowires may extend outside of the template.

The invention also includes an electronic device comprising an article, the article prepared by a process that involves forming a template on a metal current collector, the template including nanopores that extend through the template to the current collector. Nanowires of silicon are formed inside the nanopores. The nanowires may be long enough to extend until a portion of the nanowires is outside the template. After forming the nanowires of silicon, the template is removed. The resulting article of silicon nanowires on the current collector functions as an electrode (e.g. an anode) of silicon nanowires on a current collector.

The invention also includes a process for preparing an article, the process comprising: forming a template on a metal substrate, the template comprising nanopores that extend through the template to the metal substrate. After forming the template, nanowires of silicon are formed inside the nanopores. The nanowires may extend outside of the nanopores. After forming the nanowires, the template is removed. The article may be used as an anode of silicon nanowires on a metal current collector.

### BRIEF DESCRIPTION OF THE DRAWINGS

FIG. 1 shows a highly magnified Scanning Electron Micrograph image of a top view of a surface of a stainless steel disk.

FIG. 2a shows a schematic diagram of a cross-sectional side view of the stainless steel surface of FIG. 1a after (a) mechanical polishing, (b) sonication in acetone (or isopropyl alcohol), and (c) sonication in deionized water, and FIG. 2b shows the disk of FIG. 2a after coating aluminum oxide on the surface by atomic layer deposition, and FIG. 2c shows the disk of FIG. 2b after polishing the surface to remove aluminum oxide from the surface without removing aluminum oxide from inside the pits.

FIG. 3 shows a schematic diagram of the cross-sectional side view of the disk of FIG. 2a after depositing a layer of aluminum with an e-beam evaporator.

FIG. 4a shows a highly magnified scanning electron microscope image of a top view of the stainless steel disk of FIG. 3 after anodizing the aluminum layer in oxalic acid solution with a 20 V bias and a maximum current limit of 1.3 mA/mm² at 38° C. which results in oxidation of the aluminum to aluminum oxide and the formation of nanopores in the aluminum oxide layer, and FIG. 4b shows a schematic diagram of a cross-sectional side view of FIG. 4a which shows the nanopores that form through the aluminum oxide that do not reach the surface of the current collector, and FIG. 4c is a magnified portion of FIG. 4b that show the nanopores in the aluminum oxide layer that do not reach the surface of the current collector. FIG. 4d shows a highly magnified scanning electron microscope image of FIG. 4c.

FIG. 5a shows a top view of a highly magnified Scanning Electron Micrograph image after etching the aluminum oxide layer with phosphoric acid, and FIG. 5b shows a schematic diagram of a cross-sectional side view of FIG. 5a, which shows that the nanopores are wider and now extend to the surface of the current collector as a result of the etching with phosphoric acid. FIG. 5c shows a cross-sectional side view of a highly magnified Scanning Electron Microscope image after the etching with phosphoric acid.

FIG. 6a shows top view of a highly magnified Scanning Electron Microscope image after electroplating gold on the exposed surface of the disk of FIGS. 5a, 5b, and 5c. FIG. 6b shows a schematic diagram of a cross-sectional side view of FIG. 6a. FIG. 6c shows a highly magnified Scanning Electron Microscope image of a cross-sectional side view of FIG. 6a.

FIG. 7a shows a highly magnified Scanning Electron Microscope image of a top view of the disk after synthesizing silicon nanowires through the nanopores of the aluminum oxide. The nanopores though the aluminum oxide may be considered collectively to be a template through which the silicon nanowires grow. FIG. 7b shows a schematic diagram of a cross-sectional side view of FIG. 7a. In this embodiment, the nanowires extend from the stainless steel current collector, through the nanopores to the outside. FIG. 7c shows a highly magnified Scanning Electron Microscope image of a side view of FIG. 7a.

FIG. 8a shows a highly magnified Scanning Electron Microscope image of a top view of the disk after removing the template, FIG. 8b shows a schematic diagram of a cross-sectional side view of FIG. 8a, and FIG. 8c shows a highly magnified Scanning Electron Microscope image of a cross-sectional side view of FIG. 8a.

FIG. 9a illustrates schematically the delamination process of silicon nanowires on a current collector prepared with islands of silicon on the current collector, and FIG. 9b shows a highly magnified Scanning Electron Microscope image of silicon islands under silicon nanowires on the current collector.

FIG. 10a shows a schematic view of an embodiment anode prepared without silicon islands, and FIG. 10b shows highly magnified scanning electron microscope image of the embodiment anode prepared without silicon islands.

FIG. 11 left shows four highly magnified Scanning Electron Microscope images of top views of a sample prepared with islands after 40, 80, 120, and 160 electrochemical cycles, and FIG. 11 right shows four highly magnified Scanning Electron Microscope images of top views of a sample prepared without islands after 40, 80, 120, and 160 electrochemical cycles.

FIG. 12 shows specific capacity (delithiation) measurements of three samples prepared with and without islands of silicon on the current collector.

### DETAILED DESCRIPTION

This invention is concerned generally with the preparation articles that include silicon nanowires on metal substrates. In various embodiments, these articles are anodes of silicon nanowires on metal substrates that are current collectors. In these embodiments, the terms metal substrates and current collectors may be used interchangeably. In these embodiments, the silicon nanowires function as electrodes such as anodes.

An aspect of this invention relates to minimizing the formation of metal silicides during the preparation of the silicon nanowires. This was accomplished by determining suitable conditions for the synthesis of the nanowires on a stainless steel disk with a gold metal catalyst.

Another aspect of the invention relates to preventing the formation of islands of silicon on the metal substrates. This was accomplished by forming a template of nanopores on the metal substrate before synthesizing the silicon nanowires. The template allowed the growth of silicon nanowires on the metal substrate through nanopores in the template while preventing the formation of islands of silicon on the metal substrate. In various embodiments, an anodized aluminum oxide template was used to form the templates on 304 stainless steel disks. However, it should be understood that other types of templates and templating processes could equally have been used, and indeed other types of template formation and application are also within the scope of this invention.

Metal substrates that may function as current collectors are used with this invention. In embodiments used to demonstrate the invention, metal substrates were 304 stainless steel disks but it should be understood that other types of stainless steel, and indeed other types of metal structures (e.g. platinum, nickel, and the like) for the current collectors are also within the scope of this invention.

Briefly, silicon nanowires were grown on 304 stainless steel disks, The stainless steel disks were first polished with 400, 600, 800, 1200 grit paper, followed by solvent rinsing and 2 nm thick gold (Au) catalyst deposition using an electron beam (e-beam) evaporator. The polished stainless steel disks were loaded into a cold wall low pressure chemical vapor deposition reactor at a base pressure of 1.0×10⁻⁶ Torr and the samples were heated to 120° C. for 30 minutes. After that, a gas mixture of 50% SiH₄/50% H₂, and doping gas (100 ppm phosphine), were introduced with the flow rate of 250 sccm and 100 sccm respectively with a chamber pressure of 3 Torr. During the gas flow, the temperature was increased up to 450° C. and maintained for 30 minutes. At the conclusion of growth, the gas flow was stopped and temperature was set to room temperature. The resulting n-type doping concentration is estimated to be >10¹⁹/cm³. In embodiments used to demonstrate the invention, the above silicon nanowire growth conditions were used, but it should be understood that reactor conditions of gas compositions, gas flows, temperatures and sequences of operations for optimized nanowire growth will vary with details of each chemical vapor deposition reactor design, and indeed variations in the growth conditions for silicon nanowire synthesis are also within the scope of this invention.

Secondary Ion Mass Spectrometry (SIMS) was used to obtain the elemental depth profiles from the sample surfaces. The SIMS analysis was performed using an ATOMIKA 4500 quadrupole SIMS tool. Oxygen primary ion beam was used for sputtering the sample surface while positive secondary ions were recorded. The primary beam was at near normal incidence in order to minimize sample roughening artifacts. The beam was raster scanned over a 120×120 μm². The depth scale was calculated by measuring the total crater depth using a TENCOR surface profiler and assuming a uniform erosion rate.

Coin-type half cells (2032 size) were assembled in a helium-filled glove box under an atmosphere that contained less than 0.5 ppm oxygen and less than 0.5 ppm moisture. The cells consisted of silicon nanowires that were synthesized on a 304 stainless steel disk, a 25 μm thick microporous monolayer membrane as a separator (CELGARD, 2400), a 1.5 mm thick lithium foil as reference and counter electrodes (ALFA AESAR), and electrolyte, which was 1M lithium hexafluorophosphate (LiPF₆) in 1:2 (w/w) mixture of ethylene carbonate (EC) and dimethyl carbonate (DMC). Electrochemical performances were carried out using a multichannel potentiostat (BIO-LOGIC, VMP3) with a constant current mode within the voltage range of about 0.02 to about 1.5 V versus Li/Li⁺ and current and voltage data were collected at every 5 mV changes. All the samples were cycled at a low rate, 0.05 coulombs (C), (IC=4200 mA/g) in the first cycle (both lithiation and delithiation) in order to stabilize anode materials and then the cycle rate was increased in the remaining cycles.

Silicon nanowires were synthesized on the metal substrates by forming a template of aluminum oxide having nanopores that extended through the template to the metal substrate, electrodepositing a catalyst (e.g. a metal catalyst such as, but not limited to, elemental gold) on the exposed portions of the metal substrate, and using chemical vapor deposition to synthesize the nanowires through the nanopores of the template. After synthesizing the nanowires, the template was removed by etching with phosphoric acid (85%), thereby leaving the anode of silicon nanowires intact on the metal substrate. The templates prevented the formation of silicon islands as the silicon nanowires were synthesized on the metal substrates. The elimination of the silicon islands also eliminated the prior art problem of pulverization during cycling. When demonstrated as anodes, the specific capacity of the silicon nanowire anodes was very high. Typical specific is capacities observed after the second charging cycle were 1500 to 3000 mA·h/g and greater than 40% of this specific capacity was maintained for more than 200 cycles. For example, in one case the initial specific capacity of silicon nanowires prepared according to an embodiment of the invention was 3000 mA·h/g and maintained 1000 mA·h/g for over 700 cycles.

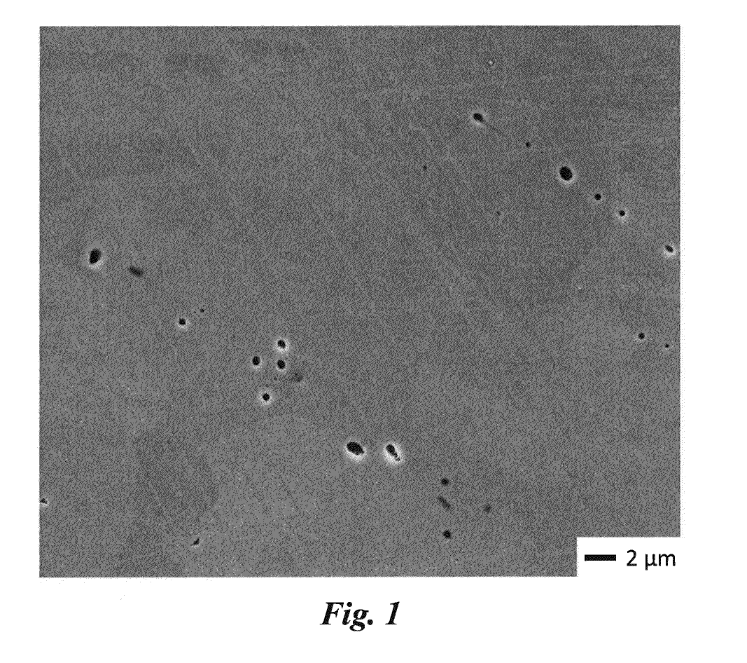

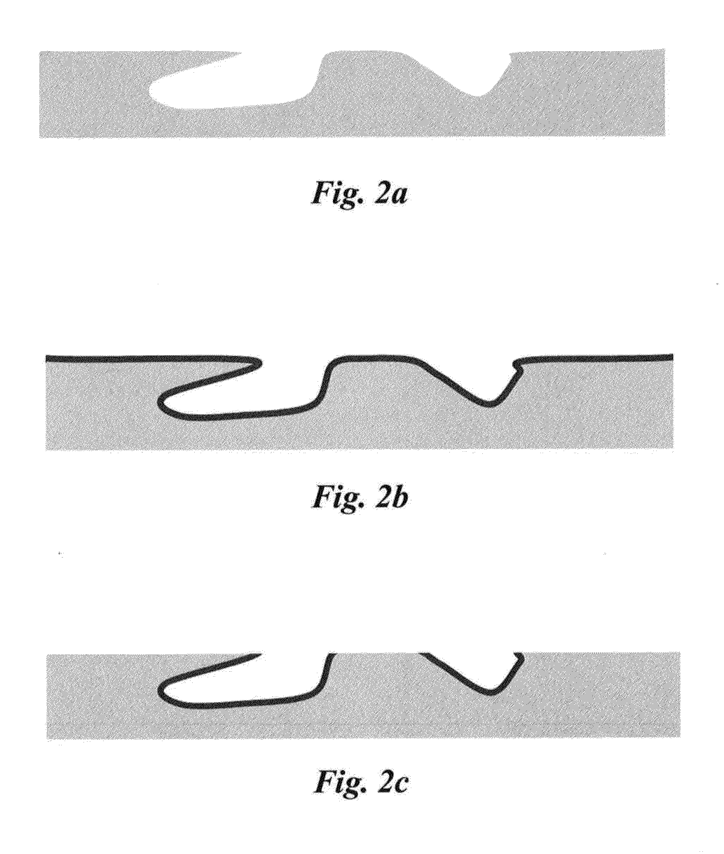

In an embodiment, a stainless steel disk was used as a current collector. Stainless steel surfaces and other metal surfaces generally include tiny pits that cannot be removed by polishing. FIG. 1 shows a highly magnified image obtained by Scanning Electron Microscopy of a surface of a stainless steel disk used to demonstrate the invention. Visible are pits in the surface. The presence of the pits makes it difficult to use the anodization process in making nanopores due to an electrical short which leads to a high current flow. To solve this problem, the stainless steel disks were subjected to an atomic layer deposition (ALD) process that coated the surfaces of the pits with aluminum oxide. Each stainless steel disk was polished with grit paper. A 400 grit paper was used first to polish the surface. Following that, the surface was polished with a 600 grit paper followed by polishing with an 800 grit paper, followed by polishing with a 1200 grit paper, and then a chemical mechanical polishing pad (CMP pad) was used to finish polishing the surface. After performing these mechanical polishing steps, each disk was sonicated in acetone, isopropyl alcohol, and afterward in deionized water. After the sonication, each disk was ready for atomic layer deposition of aluminum oxide. Each disk was coated with atomic layers (about 10 nm thick) of aluminum oxide (Al₂O₃) by atomic layer deposition. FIG. 2a shows a schematic diagram of a cross-sectional side view of the stainless steel surface of FIG. 1a after mechanical polishing, sonication in acetone, isopropyl alcohol, and then in deionized water, and FIG. 2b shows after coating aluminum oxide on the surface by atomic layer deposition, and FIG. 2c shows the disk of FIG. 2a after polishing the surface using a chemical mechanical polishing pad to remove aluminum oxide from the surface without removing aluminum oxide from inside the pits. In an embodiment, one hundred atomic layers of aluminum oxide were deposited on the stainless steel surface, and also inside the pits, which covered the surfaces of the pits with atomic layers of aluminum oxide. The deposition temperature was approximately 300° C. Afterward, each disk was polished with a CMP pad, which removed the atomic layers from the surface of the disk, but did not remove the atomic layers of aluminum oxide from inside the pinholes.

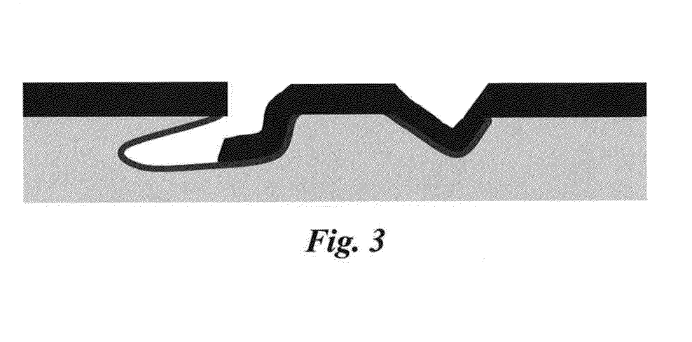

Next, a 500-1000 nm thick layer of aluminum (Al) metal was deposited on each disk using an electron beam evaporator. FIG. 3 shows a schematic diagram of the cross-sectional side view of the disk of FIG. 2a after depositing a layer of aluminum with an e-beam evaporator. As FIG. 3 shows, this layer of aluminum metal covered all line-of-sight exposed surfaces, including exposed surfaces of the pinholes that were previously coated with aluminum oxide by atomic layer deposition.

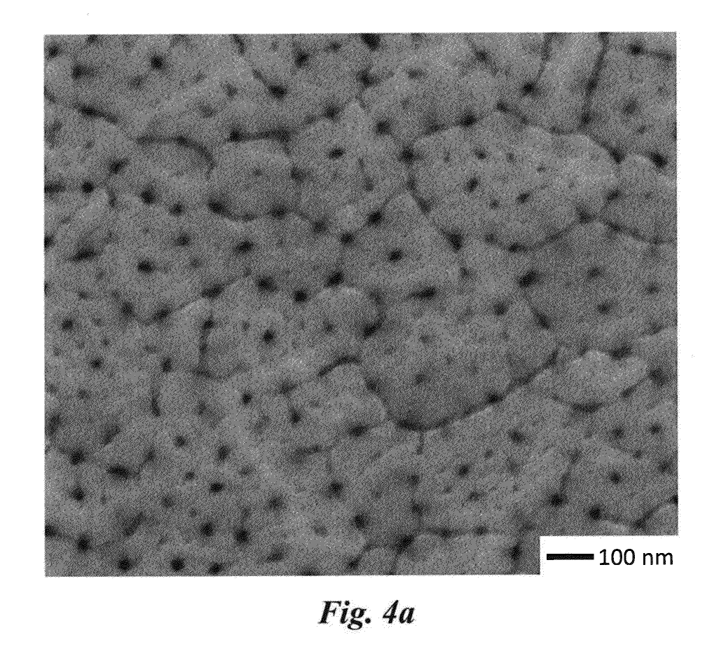

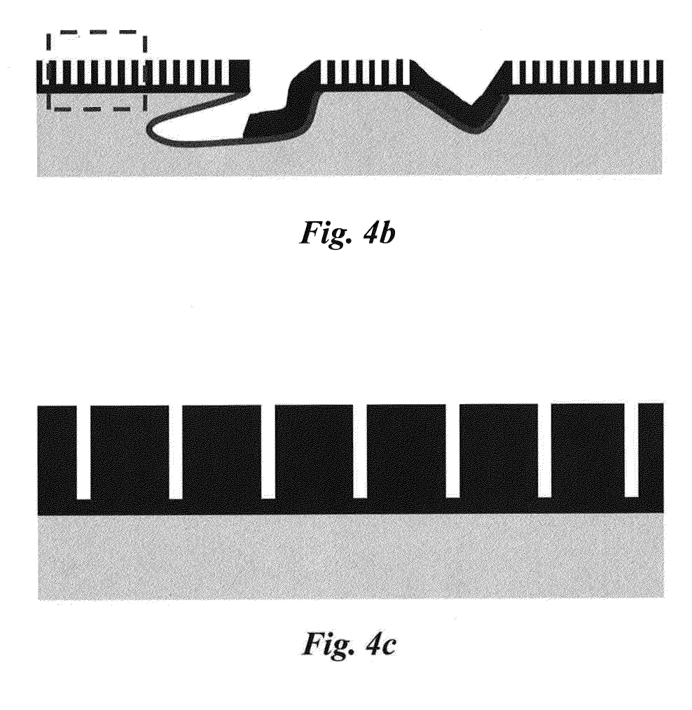

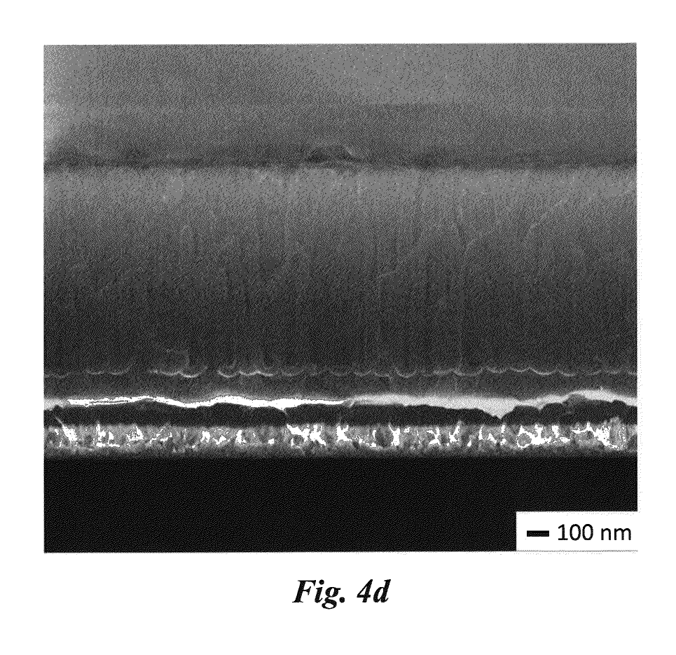

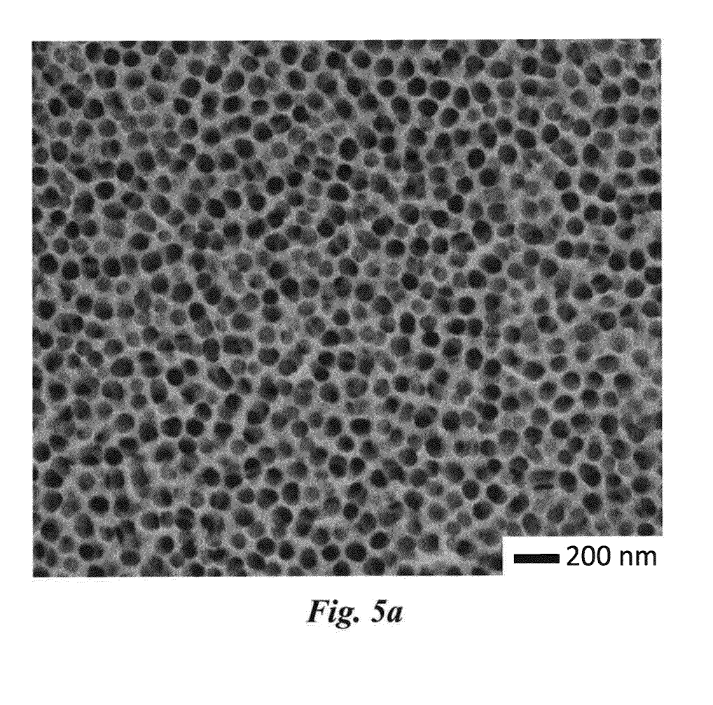

The aluminum layer was then anodized, which resulted in oxidation the aluminum to aluminum oxide and also in the formation of nanopores in the aluminum oxide. The anodizing procedure for oxidizing the aluminum and producing nanopores was previously reported (see: J. D. Edwards and F. Keller, Trans. Electrochem. Soc., vol. 79, p. 135 (1941) incorporated by reference herein; F. Keller, M. S. Hunter and D. L. Robinson, J. Electrochem. Soc., vol. 100, p. 411 (1953) incorporated by reference herein; and H. Masuda, K. Fukada, Science, vol. 268, pp. 1466-1468, (1995) incorporated by reference herein). FIG. 4a shows a highly magnified scanning electron microscope image of a top view of the stainless steel disk of FIG. 3 after anodizing the aluminum layer in an aqueous 0.3M oxalic acid solution with a 20 V bias and a maximum current limit of 1.3 mA/mm² at 38° C. Which resulted in oxidation of the aluminum to aluminum oxide and the formation of nanopores in the aluminum oxide layer, and FIG. 4b shows a schematic diagram of a cross-sectional side view of FIG. 4a which shows that nanopores that form through the aluminum oxide do not reach the surface of the current collector, and FIGS. 4c and 4d are a magnified portion of FIG. 4b that also show the nanopores in the aluminum oxide layer do not reach the surface of the current collector.

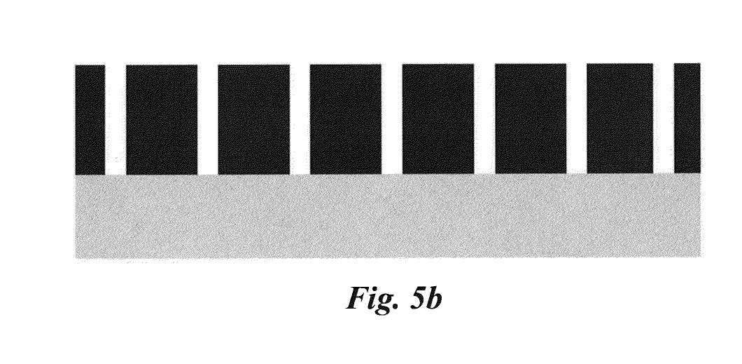

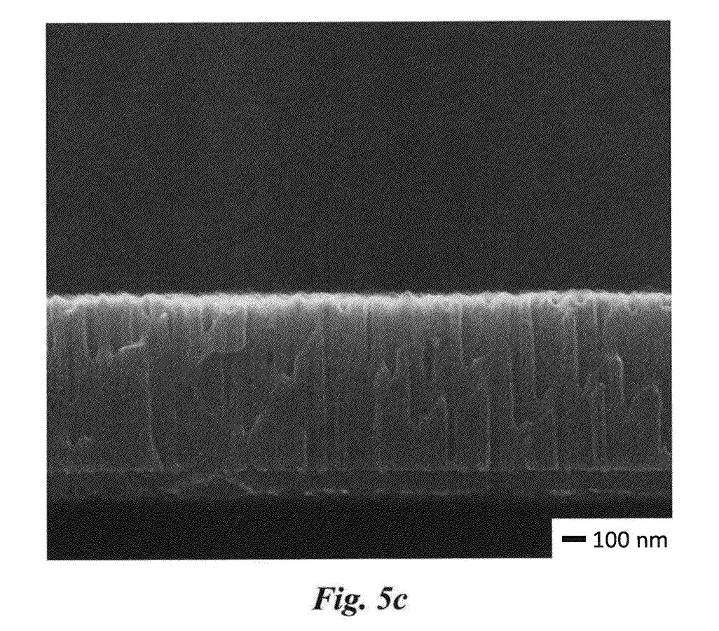

Many of the nanopores created during the anodizing procedure did not extend far enough through the layer of aluminum oxide to reach the current collector. The electroplating of the catalyst should deposit the catalyst on the current collector, but some is of the aluminum oxide still blocked the surface. Therefore, an additional treatment step was performed to remove some additional aluminum oxide in order to extend the nanopores until they reached the current collector. Each sample was etched using a dilute solution of phosphoric acid (e.g. 5% H₃PO₄) for about 15 minutes at a temperature of about 32° C. This etching extended the nanopores until they reached the current collector, and the etching also widened the nanopores. FIG. 5a shows a highly magnified Scanning Electron Micrograph image after etching the aluminum oxide layer with phosphoric acid, and FIG. 5b shows a schematic diagram of a cross-sectional side view of FIG. 5a, which shows that the nanopores are wider and now extend to the surface of the current collector as a result of the etching with phosphoric acid. FIG. 5c shows a highly magnified cross-sectional side view Scanning Electron Microscope image after the etching with phosphoric acid. The scale shown on the bottom right of FIG. 5a can be used to estimate the width of the nanopores, which appear to be about 40-100 nanometers in width, although narrower and wider nanopores would also be suitable and would result depending on the etching time, concentration of phosphoric acid, anodization bias voltage, etc. A thicker template layer with wider nanopores would produce longer and wider silicon nanowires, while thinner and narrower nanopores would produce shorter and thinner silicon nanowires.

A metal catalyst on the current collector is required for growing the silicon nanowires. With the nanopores now reaching the current collector, the sample was now ready for deposition of the metal catalyst on the current collector. Examples of catalysts useful for synthesizing the silicon nanowires include noble metals gold (Au) and platinum (Pt). Nickel (Ni) is also a suitable catalytic metal. It should be understood that the invention should not be limited to any particular catalyst, and that any catalyst suitable for being deposited on the current collector and for catalyzing the synthesis of the silicon nanowires is within the scope of this invention.

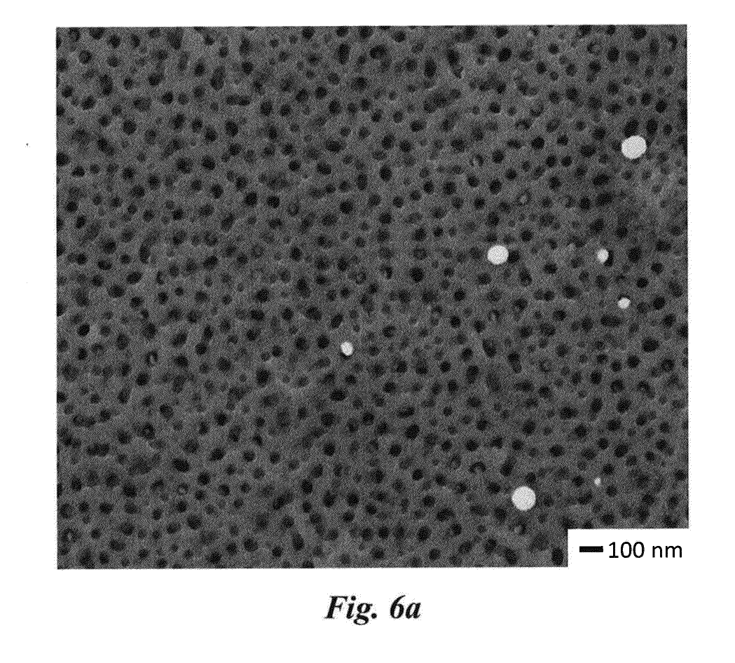

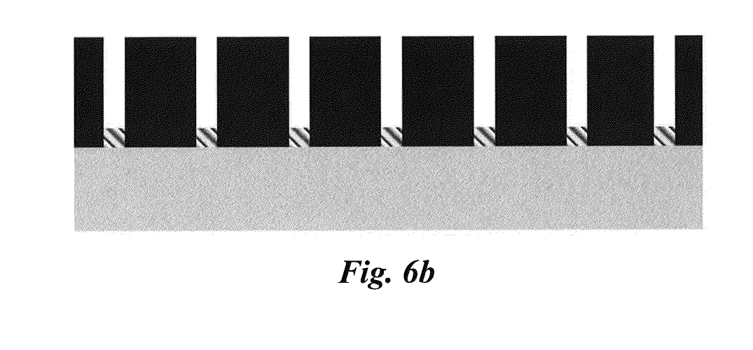

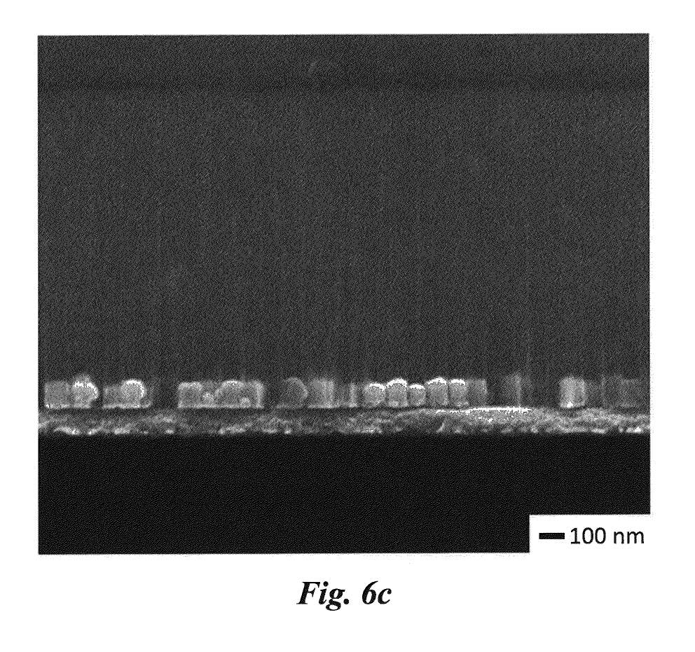

Following the etching procedure, the sample was subjected to a catalyst deposition procedure known in the art as electroplating. The current collector (i.e. metal substrate) was electroplated with gold. The invention is not limited to any particular electroplating technique or electroplating material so long as the electroplating results in deposition of a catalytic metal on the current collector, particularly on the surfaces of the current collector that have been exposed as a result of the prior etching to extend the nanopores to the current collector. In an embodiment, gold electroplating was performed using a commercially available material known as TECHNI-GOLD 25 (TECHNIC INC., Cranston, R.I.) from which a formation known as TECHNI-GOLD 25 E S may be prepared according to instructions available from the supplier (TECHNIC INC., Cranston, R.I.). The material is neutral non-cyanide gold plating formation that was used for the electroplating the current collector. Instructions for the electroplating are also available from the supplier. The stainless steel disk was soaked in Au plating solution. Afterward, the disk was connected to a negative terminal and a positive terminal was connected to a metal anode (Pt). A constant current of about 2 μA/mm²) was applied for about 30 seconds, which deposited (i.e. electroplated) gold on the exposed areas of the current collector in the template. The deposited gold array had a thickness of about 50 nm to about 100 nm. After the gold deposition, the sample was washed several times with deionized water. The electroplated gold acted as a catalyst for the growth of silicon nanowires. FIG. 6a shows a highly magnified Scanning Electron Microscope image after electroplating gold on the exposed surface of the disk of FIGS. 5a, 5b, and 5c. FIG. 6b shows a schematic diagram of a cross-sectional side view of FIG. 6a. FIG. 6c shows a highly magnified Scanning Electron Microscope image of a cross-sectional side view of FIG. 6a.

Following the gold electroplating, silicon nanowires (SiNWs) were grown. The conditions for growing the silicon nanowires were chosen in order to minimize the formation of metal silicides. These conditions for minimizing the formation of metal silicides were determined in a series of experiments prior to forming the template. Minimizing the formation of metal silicides on stainless steel current collectors is desirable because metal silicide formation decreases the weight percent (wt %) of silicon in the nanowires which results in reduced overall specific capacity of the electrode. In order to enhance the specific capacity of the electrode, the weight percent of the high capacity material (i.e. the silicon nanowires) should be maximized and the weight percent of lower specific capacity material (the metal silicides) should be minimized.

We studied the effect of metal silicide formation on a silicon nanowire-based Li-ion battery anode capacity. Our results show that metal silicide formation with its low specific capacity for Li storage reduces overall specific capacity of a silicon nanowire-based lithium-ion battery anode. Low capacity retention is a major limitation to date for commercialization of high performance silicon anodes.

To enhance specific capacity, the weight percent of an anode material having high specific capacity should be maximized while that of any poorly reactive anode material with Li should be minimized provided the poorly reactive anode material does not have any additional hybrid function to enhance battery performance, such as cyclability or power density.

To quantitatively characterize formation of silicon nanowires and competing formation of metal silicides, control experiments with three different substrates were performed. The substrates were Si chips, Si chips with a 2 nm thick gold (Au) catalyst which was deposited using an electron beam (e-beam) evaporator, and polished 304 stainless steel disks. These substrates were loaded into a cold wall, low pressure chemical vapor deposition (CVD) reactor together and the samples were heated to a nanowire growth temperature. Once the temperature was stabilized, silane (50% SiH₄ in H₂) and doping gas (100 ppm phosphine) were introduced with the flow rates of 250 sccm and 100 sccm respectively and a chamber pressure of 3 Torr for 20 minutes. For the silicon chip, only silicon (Si) film was deposited on the Si chip. No metal silicide formed on the silicon ship because there was no metal present for metal silicide formation. No silicon nanowires formed because no catalyst was present for silicon nanowire growth. On the silicon chip having 2 nm thick Au catalyst, nanowires were grown with Si film deposition. On the stainless steel disk, metal silicide formed, but nanowires did not form because there was no Au catalyst. The weight of nanowires was obtained from the weight change of the Si chip with Au catalyst after subtracting the weight of Si film which was measured from a Si chip sample without Au catalyst. The weight of metal silicide was determined from the weight change of the stainless steel disk.

Three identical samples for each substrate were prepared, and the average areal mass gains (μg/mm²) of the each three materials (Si film, SiNWs, and metal silicide) were obtained after CVD processing for different growth temperatures. As the temperature increased, the areal mass gains of the three materials increased with the Si film showing the lowest growth rate. The overall mass gain of the nanowires was higher than that of metal silicide. No mass gain was observed from all materials below 400° C. for a microbalance with 0.1 μg resolution capability. Metal silicide and nanowires showed mass gain at 450° C., but Si film did not show mass gain until 500° C. Weight gains above 600° C. were not measured because delamination of the metal silicide film occurred from the 304 stainless steel (SS) disks during the CVD process due to excessive Si-rich metal silicide formation. The Si-rich metal silicide layer induces high compressive film stress and the high stress caused the metal silicide to buckle and delaminate. The depth profiles of Si from the SS surfaces were obtained before and after CVD processing at 450, 525, and 570° C. for 20 minutes with a Secondary Ion Mass Spectrometry (SIMS) in order to verify metal silicide formation and characterize silicide thickness formed at different CVD growth temperatures. The metal silicide was deeper with increasing CND growth temperature, which is consistent with our indirect Observation of increasing mass gain with growth temperature. CVD processing at 570° C. and 525° C. shows the Si signals extend to a depth of 800 nm and 500 nm, respectively. A sample processed at 450° C. showed very shallow metal silicide formation (40 nm deep) and low signal intensity compared to the other two samples processed at 525° C. and 570° C. Moreover, the depth profiles for 450° C. were similar to those of the samples before CVD processing. This means an extremely small amount of metal silicide forms at or below 450° C.

Based on the measured areal mass gains of metal silicide SiNWs, and Si film, the weight percents of metal silicide vs. growth temperatures shows a parabolic increase in silicide formation with growth temperature followed by a maximum at 550° C. To minimize silicide formation on the current collectors, one needs to avoid nanowire growth at 550° C. and grow at lower temperatures. The growth temperature should be higher than 400° C. because there is no metal silicide formation and no SiNW growth below 400° C. Thus, we determined that the amount of metal silicide on metal current collectors could be controlled if the growth temperature is from about 400° C. to about 500° C., or from about 410° C. to about 490° C., or from about 420° C. to about 480° C., or from about 430° C. to about 470° C., or from about 440° C. to about 460° C., or about 450° C.

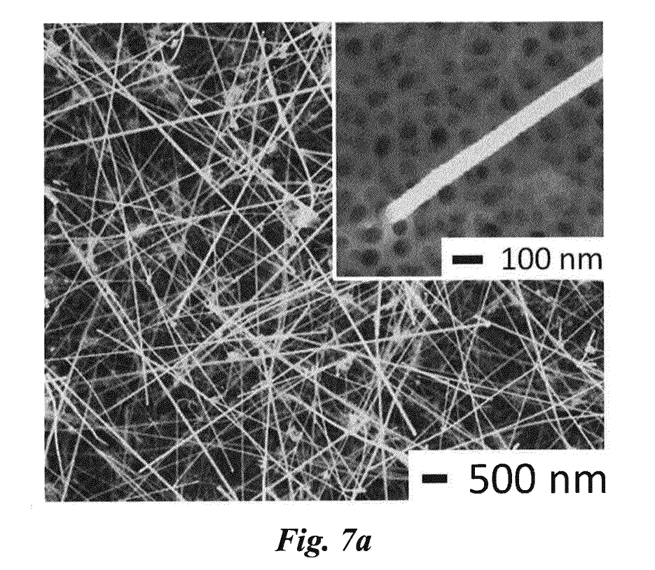

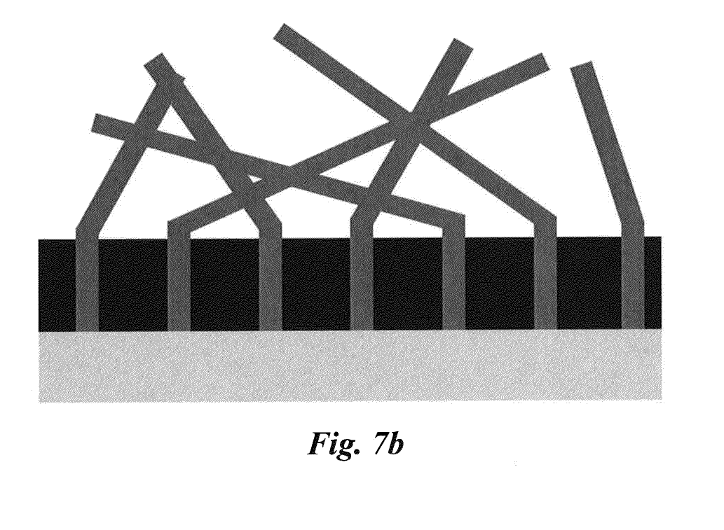

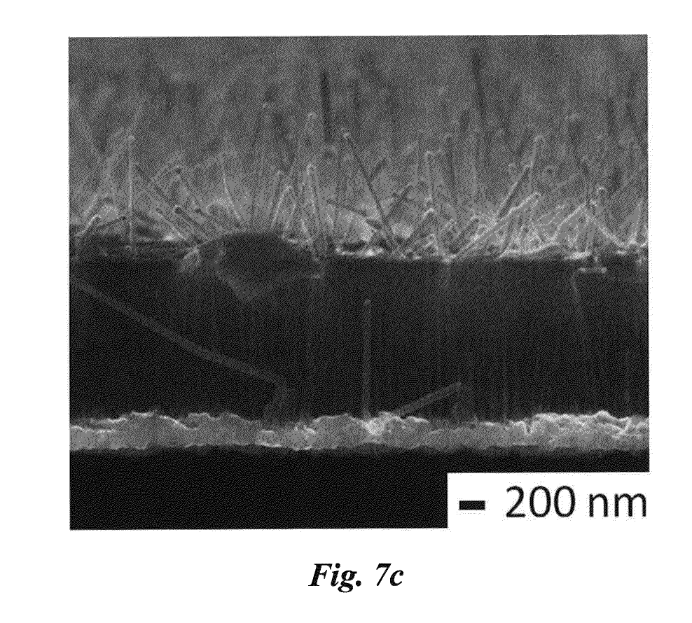

After determining the conditions in which to minimize metal silicide formation, we used these conditions to grow silicon nanowires through the nanopores in the template. The nanowires were grown in a cold wall low pressure CVD reactor at a base pressure of 1.0×10⁻⁶ Torr with a flow rate of 250 scan of a gas mixture of 50% SiH₄/H₂, and a flow rate of 100 sccm of a doping gas (100 ppm phosphine) at a temperature of 450° C. and a pressure of 3 Torr. FIG. 7a shows a highly magnified Scanning Electron Microscope image of a top view of the disk after synthesizing silicon nanowires through the nanopores of the aluminum oxide. In embodiments of this invention that involve the use of nanopores to guide the synthesis of silicon nanowires, the nanopore-containing layer, which in this case is the nanopore-containing aluminum oxide on the current collector, may be considered to be a template, and the silicon nanowires grow inside the nanopores in the template. FIG. 7b shows a schematic diagram of a cross-sectional side view of FIG. 7a. FIG. 7c shows a highly magnified Scanning Electron Microscope image of a side view of FIG. 7a. The figures show that silicon nanowires have formed inside the nanopores. The template thus has provided a guide for the synthesis of the nanowires. There is space in between the nanowires that is occupied by the aluminum oxide. In addition, the growth mechanism for the nanowires appears to be a tip growth mechanism because gold catalyst was detected at the tip of the nanowires. The gold moved outside the template as the nanowires grew longer and moved outside the template.

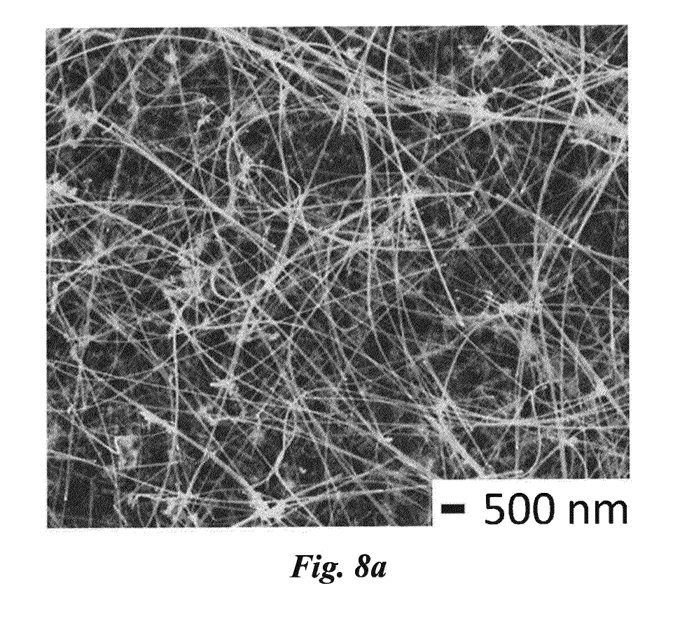

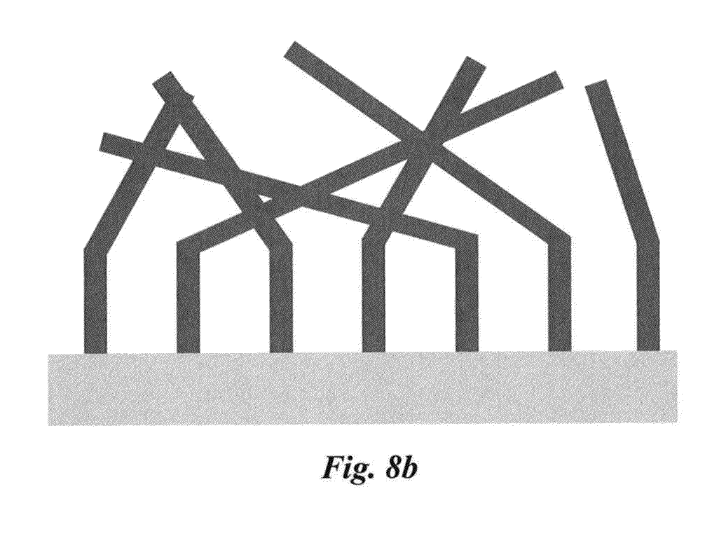

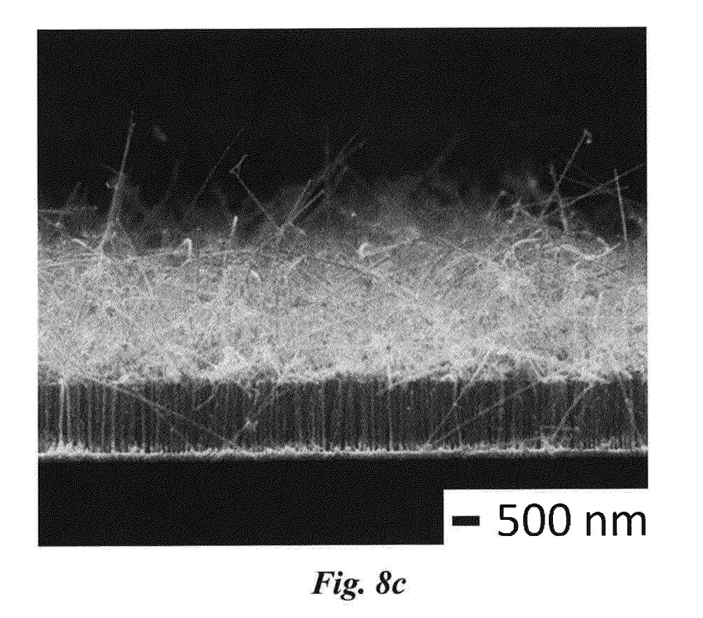

After synthesizing the SiNWs, the aluminum oxide template was removed by an acid treatment. This acid treatment involved subjecting the article to concentrated phosphoric acid (85%) for 20 minutes at a temperature of about 85° C. FIG. 8a shows a highly magnified Scanning Electron Microscope image of a top view of the disk after removing the template. FIG. 8b shows a schematic diagram of a cross-sectional side view of FIG. 8a, and FIG. 8c shows a highly magnified Scanning Electron Microscope image of a cross-sectional side view of FIG. 8a. As these images show, the template has been removed and the result is an array of silicon nanowires that are attached to the current collector.

Anodes of silicon nanowires grown as described herein have a high specific capacity and excellent cycling performance. For example, examples of anodes of silicon nanowires on stainless current collectors grown using the template method as described above have been cycling over 700 times with a specific capacity of 1000 mA·h/g. The silicon nanowire-based electrode without metal silicide formation has a high rate capability and specific capacity.

Rate capabilities of 1912 and 997 mA h/g were observed at 10C (42 A/g) and 20C (84 A/g), respectively. It is believed that these rate capabilities far exceed those for known silicon nanowire-based electrodes. The specific capacities are one order magnitude higher than that of metal silicide and twice as high as that of the 40% metal silicide and 60% SiNW sample.

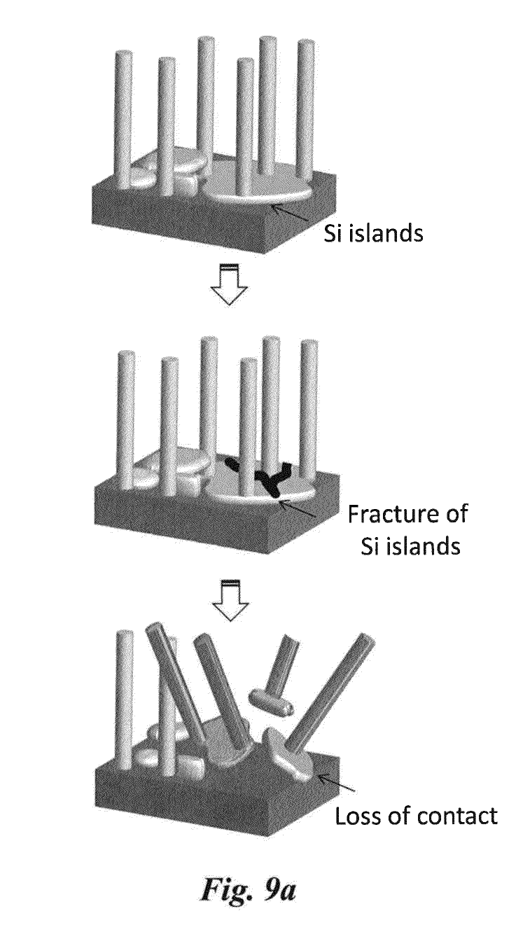

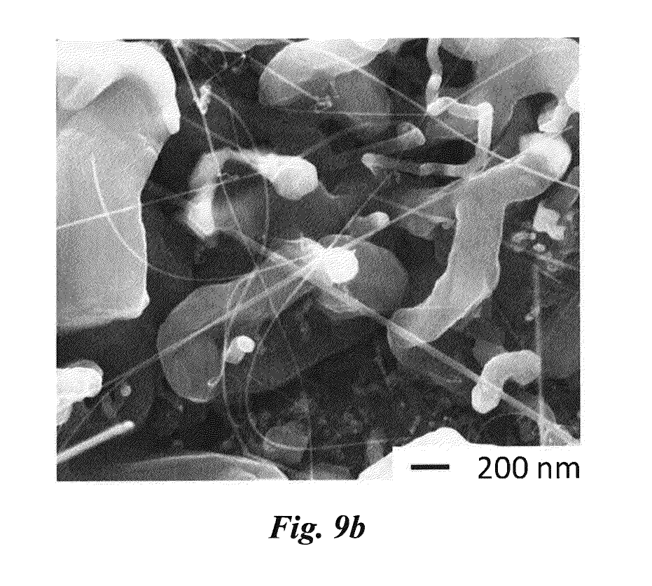

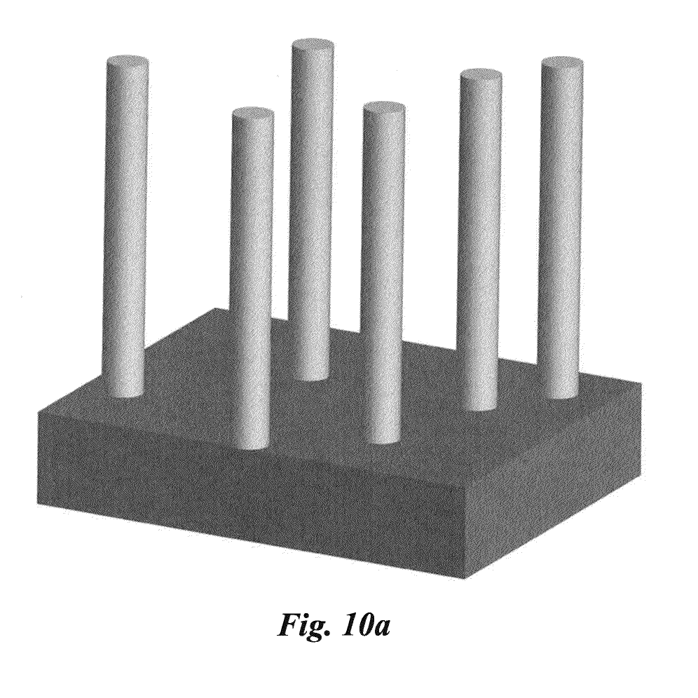

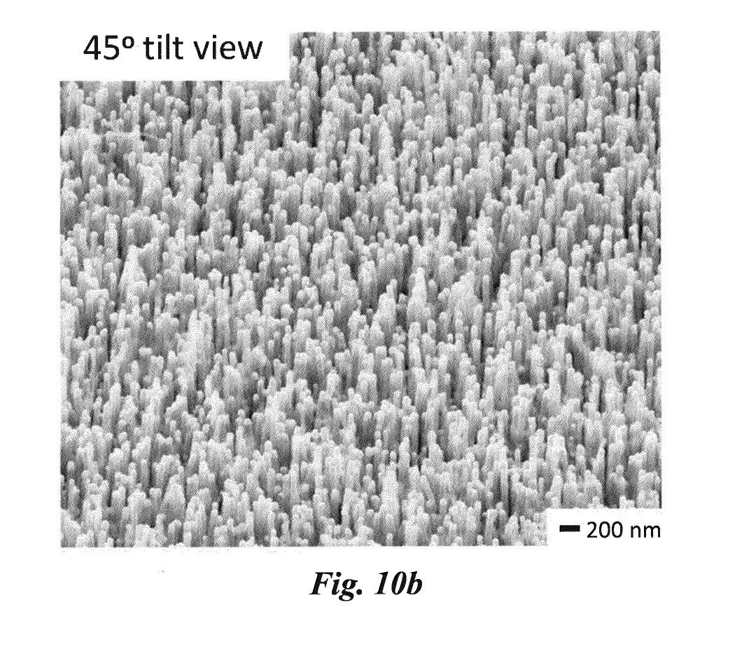

FIG. 9a shows a schematic drawing of an anode of silicon nanowires on a current collector prepared with islands, and FIG. 9b shows a highly magnified Scanning Electron Microscope image of such an anode. By comparison, FIG. 10a shows a schematic diagram of an embodiment anode prepared without islands and FIG. 10b shows a highly magnified Scanning Electron Microscope image of an embodiment anode prepared without islands of silicon on the current collector.

FIG. 11 shows a highly magnified Scanning Electron Microscope image of a top view of the two samples prepared with and without islands of silicon. The images were captured after 40, 90, 120, and 160 electrochemical cycles which were carried out using a multichannel potentiostat with a constant current mode at 0.5C (2100 mA/g) within the voltage range of 0.02 to 1.5V vs. Li/Li⁺. The samples with islands of silicon under silicon nanowires show cracks getting bigger and wider with cycle numbers. By contrast, the samples without islands of silicon under silicon nanowires does not show any mechanical distortion and crack growth over the samples.

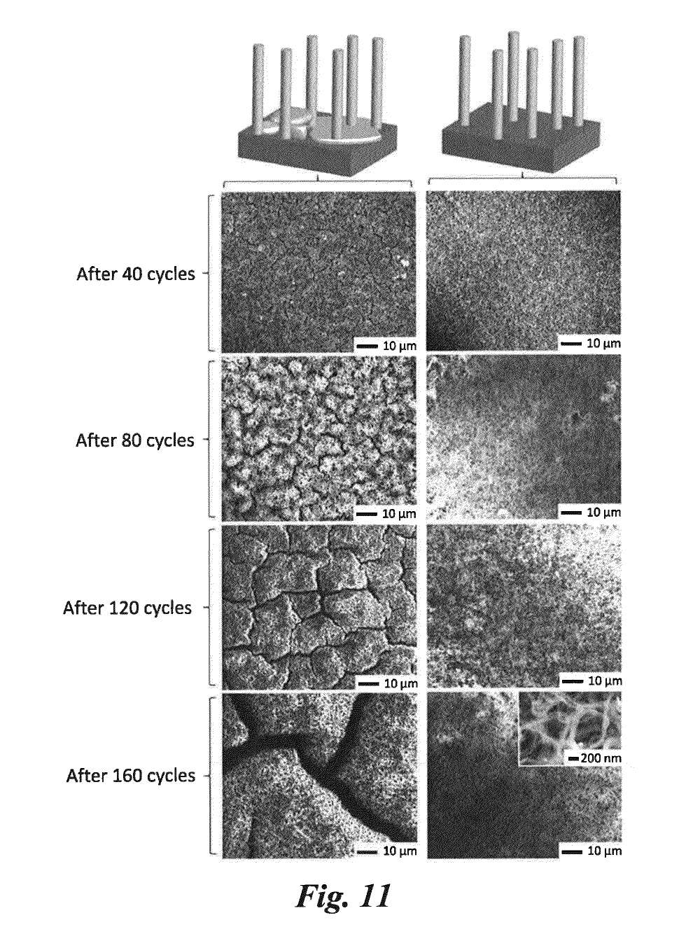

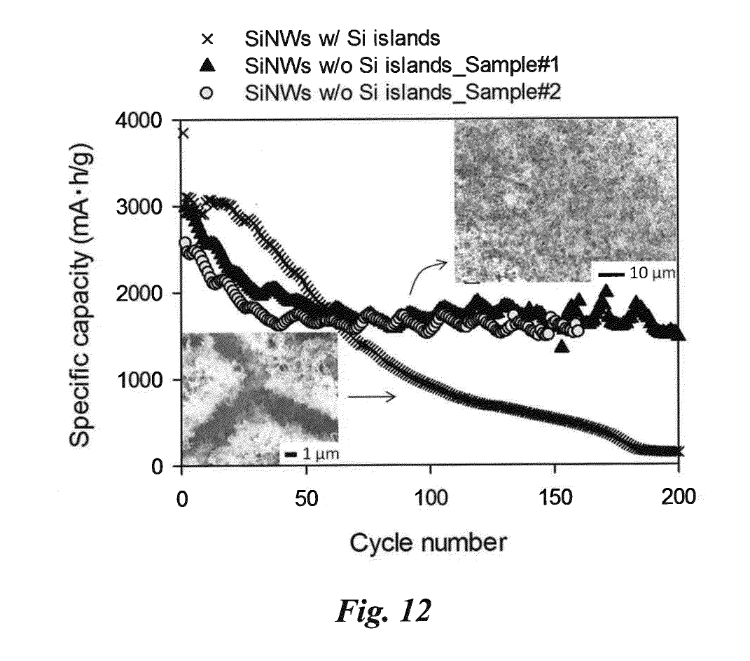

FIG. 12 shows specific capacity (delithiation) measurements of three samples prepared with and without islands of silicon on the current collector. The sample with islands of silicon under silicon nanowires shows cracks as cycle number increased, and the cracks leads to loss of electrical contact with a current collector. Due to the loss of electrical contact, specific capacities are getting lower as the number of cycle increases and eventually go to zero. However, the samples without island formation under silicon nanowires do not have the cracking problem like the sample with island of silicon and show consistent specific capacities after 40 cycles over two hundred cycles.

Minimizing the formation of metal silicide during the CVD process for synthesizing silicon nanowires increases the specific capacity and rate capacities. The performance of a silicon nanowire-based lithium-ion battery anode is greatly improved by optimizing the nanowire growth temperature to minimize metal suicide formation. The silicon nanowires have higher specific capacity than previously reported, and also that charge-discharge rate capability Were the highest values ever reported for silicon nanowire anodes grown directly on metal current collectors. The templates prevented the formation of silicon islands on the current collector. Anodes prepared using the templates have demonstrated a high specific capacity and excellent cycling performance. These anodes are expected to be useful in portable electronic systems, in electronic vehicles, and for other electronic devices such as, but not limited to, batteries (e.g. lithium ion batteries), thermoelectric devices, photovoltaic devices, sensors, and the like, including devices that have electrodes (e.g. anodes, for example) due to the enhanced cyclability, high specific capacity, and cycle rate capability of the anodes. As device components, these embodiment articles of silicon nanowires on current collectors are expected to be parts of electronic circuits that include, but are not limited to, capacitors, resistors, transistors, diodes, sensors, actuators, and the like.

Although the present invention has been described with reference to specific details, it is not intended that such details should be regarded as limitations upon the scope of the invention, except as and to the extent that they are included in the accompanying claims.

What is claimed is:

1. An article prepared by a process comprising:
forming a template on a metal substrate, the template comprising nanopores that extend through the template to the current collector,
forming nanowires inside the nanopores, and
removing the template.

2. The article of claim 1, wherein the metal substrate comprises stainless steel, nickel, copper, iron, or platinum.

3. The article of claim 1, wherein the nanowires comprise silicon, germanium, or an alloy of silicon and germanium.

4. The article of claim 1, wherein the template comprises aluminum oxide.

5. The article of claim 1, further comprising electroplating a catalyst onto portions of the metal substrate that are exposed by the nanopores after forming the template on the current collector.

6. The article of claim 4, wherein the metal substrate comprises a surface having pits.

7. The article of claim 6, wherein the step of forming the template includes:
coating the pits with aluminum oxide,
removing the aluminum oxide on the metal substrate surface without removing aluminum oxide from inside the pits,
forming a layer of aluminum metal on the metal substrate,
anodizing the layer of aluminum to oxidize at least some of the aluminum to aluminum oxide and also form nanopores in the layer of aluminum oxide, and thereafter
etching the now anodized layer comprised of aluminum oxide to widen the nanopores and extend the nanopores to the metal substrate, thereby exposing portions of the metal substrate.

8. The article of claim 7, wherein the pits in the metal substrate are coated with atomic layers of aluminum oxide.

9. The article of claim 7, wherein the layer of aluminum is grown by electron beam evaporation of aluminum onto the current collector.

10. The article of claim 7, wherein the step of anodizing comprises exposing the layer of aluminum to a solution comprising oxalic acid under conditions suitable for the conversion of aluminum to aluminum oxide and the formation of nanopores.

11. The article of claim 7, wherein the step of anodizing comprises applying a bias voltage.

12. The article of claim 1, further comprising determining the density of the nanopores.

13. The article of claim 6, wherein the step of etching to widen the nanopores and extend them to the metal substrate comprises treatment with phosphoric acid.

14. An article prepared by a process comprising:
forming a template on a metal substrate, the template comprising nanopores that extend through the template to the metal substrate,
forming nanowires of silicon inside the nanopores, and
extending nanowires of silicon from the metal substrate through the nanopores to the outside.

15. The article of claim 14, wherein the template comprises aluminum oxide.
